(19) United States
(12) Patent Application Publication
(10) Pub. No.: US 2005/0267833 A1
(43) Pub. Date: Dec. 1, 2005

(54) Method and a system for complex price calculations in automated financial trading

(75) Inventors: Jorgen Brodersen, Stockholm (SE); Henrik Jarl, Stockholm (SE)

Correspondence Address: NIXON & VANDERHYE, PC, 901 NORTH GLEBE ROAD, 11TH FLOOR, ARLINGTON, VA, 22203, US

(73) Assignee: OM Technology AB, Stockholm (SE)

(21) Appl. No.: 10/854,786

(22) Filed: May 27, 2004

(51) Int. Cl. G06F 17/60

(52) U.S. Cl. 705/37

(57) ABSTRACT

The invention discloses a function in an automated system for trading in one or several financial instruments. The function of the invention is used for calculating the price of an instrument which has been agreed upon between a first party, a seller, and a second party, a buyer, and comprises an automated sub-function for enabling the first and the second party to interactively define the instrument which is to be traded, an automated sub-function for retrieving data regarding the instrument, an automated sub-function for using said retrieved data to calculate a price for the instrument, and an automated sub-function for storing calculated prices.

### TECHNICAL FIELD

The present invention discloses a system for automated trading in one or several financial instruments, the system having a unit with means for calculating the price of an instrument which has been agreed upon between a first party, a seller, and a second party, a buyer. The present invention also relates to a corresponding method.

In addition, the system and the method of the present invention can also comprise means and steps for facilitating so called “swaps”.

### BACKGROUND ART

In automated financial trading systems, trading can be carried out between buyers and sellers of instruments such as individual papers, i.e. bonds, shares etc. Such trading is usually relatively straightforward and uncomplicated, involving so called “delivery versus payment”, i.e. a defined amount of a commodity, usually one of the mentioned kinds of instruments, is exchanged for a correspondingly agreed upon sum of money.

However, the trading in the described system can also involve more complex contracts such as stock options, of which there is a variety of different kinds, or so called “exotic options”, such as, for example, the so called Asian Option and similar option contracts. A common denominator for such contracts is that the value of the contract can be calculated in a multitude of different manners, the exact mechanism of which is agreed upon between the buyer and the seller when the contract is finalized between the buyer and the seller.

Trades or contracts such as those mentioned as examples above can, when finalized, be made dependent on the maximum or minimum price of the underlying instrument/instruments during a certain period of time, or an average of the instrument's price during the same period. The contract can be “triggered”, i.e. initiated, when the underlying instrument (which can be a “basket” of different various instruments) reaches a certain minimum or maximum level.

Due to the very nature of the instruments shown by way of example above, calculating the correct price can be difficult, and can lead to controversies.

Another source of controversies in contemporary financial trading systems can be so called “swaps”. The mechanism of a swap will be described in more detail in the following description. However, one of the reasons for controversies in connection with swaps is that today, swaps are agreed upon verbally between two parties. The details of the swap are then written down by one of the parties, and sent—usually via telefax—to the other party for approval.

One of many problems associated with this is that the faxed (draft) agreement might be handled by a large number of people at both ends, thus causing delays and confusion, which might lead to the agreement never being finalized, or at least finalized later than planned.

In addition, since many actors in the market handle a large number of swaps per day, many payments can be made between the same actors during one and the same day. This makes it difficult for the individual actors, e.g. banks, to keep track of the flow of payments going to other actors in the market.

### DISCLOSURE OF THE INVENTION

There is thus a need for an automated system for calculating the prices of more complex instruments such as, for example, options.

This need is addressed by the present invention in that it discloses an automated system for trading in one or several financial instruments, said system comprising a unit for calculating the price of a contract which has been agreed upon between a first party, a seller, and a second party, a buyer.

The unit of the invention comprises automated means for enabling the first and the second party to define the contract which is to be traded. Suitably but not necessarily, this defining is done in interaction with the automated system, but can also be done on a “stand alone” basis between the first and second party, using a unit according to the invention.

The unit of the invention also comprises automated means for retrieving data regarding said contract, and for using said retrieved data to calculate a price for the contract. Said calculated prices will also automatically be stored by the unit of the invention.

There is also a need for an improved mechanism for handling swaps, said mechanism suitably being easy to integrate in a system which incorporates the other parts of the present invention, i.e. along with those aspects of the invention which deal with calculating the prices of complex instruments. This need is addressed by a second aspect of the present invention.

### BRIEF DESCRIPTION OF THE DRAWINGS

The invention will be described in more detail in the following text, with reference to the appended drawings, in which

FIG. 1 is a diagram showing a contract to which a first aspect of the present invention might be applied, and

FIG. 2 is a flow chart which shows some of the major steps according to the first aspect of the invention, and

FIG. 3 is a rough block diagram which shows some of the major components and interactions in a system which utilizes the first aspect of the invention, and

FIG. 4 provides an overview of interaction in a second aspect of the invention, and,

FIG. 5 is a rough flowchart of a method for use in the second aspect of the invention

### EMBODIMENTS

As mentioned initially, the unit and method of the invention can be applied to a large number of contracts involving different financial instruments, such as, for example, stock options. There are a number of different kinds of stock options, such as, for example, so called European style options, American style options and Asian style options. As will become apparent from the following description, the invention will work equally well for options of all kinds, as well as for other complex financial contracts, but in order to enhance the understanding of the invention, an example will be used, the example involving a so called Asian Option.

The basis of the Asian Option is the average value of one or more underlying financial instruments such as shares over a defined period of time, the “life span” of the option. The period of time, the “life span”, as well as the underlying instrument/s is agreed upon between the parties involved in the contract, i.e. the seller and the buyer, when the contract is agreed upon.

The Asian Option is such that if the average value over said period of time is above the so called “Strike Price”, the option will be to the advantage of one party, and if the average value is below the “Strike Price”, the option will be to the advantage of the other party. The Strike Price is a value which is agreed upon between the seller and the buyer.

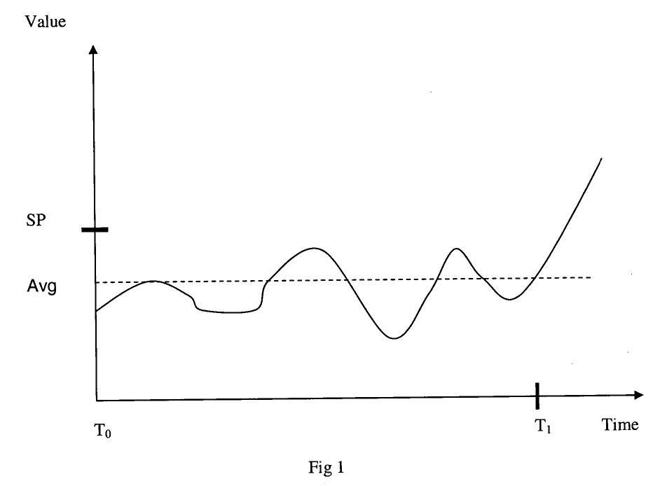

FIG. 1 shows the value (y-axis) over time (x-axis) of an Asian Option, the value being shown between two points in time, T₀ and T₁, which thus define the “life span” of the option. Also shown in FIG. 1 is the average value of the option, and the “Strike Price”.

In current trading systems, contracts in complex instruments such as Asian Options are agreed upon, initially verbally between two parties, usually brokers, one representing each side of the contract, i.e. the buyer and the seller. Once there is a verbal agreement between the two parties, each side will, in current systems, send the details of the contract, in paper form, to their respective “Back Office”, i.e. administrative departments who will complete and formalize the contract.

Since several parties are involved (at least two stock brokers, each with their respective back office staff) there is a risk of the contract being delayed or misunderstood, or at worst, never finalized. The present invention offers a method which will eliminate these risks, a method which will be elaborated upon later. First, however, some of the parameters which might lead to misunderstandings will be described.

As mentioned previously, the value of the Asia Stock Option shown in FIG. 1 will be dependent upon the average value of the underlying instrument/s. However, one parameter which might cause confusion is the definition of the average value: at what point or points in time should the values used for calculating the average be sampled? How often, and at what time or times of the day? Every hour, or, for example, the closing time of a certain trading system each day? Which mathematical formula should be used for calculating the average value?

Another parameter which can cause confusion is the “life span” of the Asian Option, i.e. the two points in time T₁ and T₀.

By means of the invention, a standardized automated interface is offered, along with an automated function for completing and finalizing the contract.

The standardized automated interface according to the invention will, by definition, be the same for all parties involved in setting up the contract. Usually only two parties will be involved, as mentioned earlier, but the interface of the invention can be used by a larger amount of users.

Thus, when the parties involved in the contract have finished setting up the parameters of the contract, the contract will be sent to their respective back offices for administrative processing, as an alternative to which the contract may be sent to a single common intermediary, such as a so called Clearing House or a Settlement Agent, who will administer the contract. By means of using a standardized interface when defining the contract, most, if not all, ambiguities in the contract will be eliminated. It should be pointed out that the standardized interface of the invention is used together with a automated function for correlating the input given by those using the interface, meaning that different choices to the same parameters will not be accepted.

The standardized interface according to the invention will normally be installed in a computer at a third party such as the Clearing House or a settlement agent, with the trading parties accessing the function via computer connections, but the interface can also be executed on the computer systems of one or both of the trading parties, i.e. used as a “stand-alone” unit .

The standardized interface according to the invention may take on a variety of different graphic layouts, for which reason the interface will be shown in this text by means of the various choices which it offers, instead of showing a particular graphic design. The following parameters may be defined by those using the interface:
Underlying instruments of the contract, and for baskets or indices, the relationships among the underlying instruments, e.g. X % of instrument A and Y % of instrument B.
Rules of the contract:
   points in time when values should be sampled,
   frequency and timing of said sampling,
   arithmetic models to be used in calculations,
   starting and termination times for the contract.
   how to handle capital adjustments and corporate events of underlying instruments, e.g. splits or emissions.

The unit of the present invention also comprises automated means for retrieving data regarding the contract: once the contract is finalized by means of the automated interface and its associated control function, the contract is by automated means such as a computer function, sent to the retrieval function.

The purpose of the retrieval function is, as might be inferred from the name, to retrieve data regarding the contract, said data being among the data agreed upon through the interface function, i.e. the data which determines the price of the contract. As an example, for an Asian Option, the data which is retrieved is thus the price data of the instrument/s underlying the option, which data goes into the calculation of the average value.

The data which is retrieved is done so at the agreed upon points in time, or with an even higher frequency. The data is retrieved from the relevant systems by means of automated interfaces, said relevant systems being systems which can be either the system in which the invention is applied, or external systems such as (other) financial trading systems or, for example, news services or so called vendor feeds, i.e. services offering such pricing information

The unit of invention also comprises automated means for using retrieved data to calculate the price of the contract. This is done at regular intervals, which are at least of the frequency agreed upon in the contract, or made necessary by the contract. Also by means of the invention, there is provided an automated function for storing the calculated prices, which are then stored together with information about the point in time when the data used for the price calculation was retrieved. Thus, a virtual “ticker tape” can be created for the price or the value of the contract.

The prices or values which are calculated are thus stored by an automated function according to the invention. All of the units of the invention can be run on one and the same computer, or linked via a computer network so that the units are run as “stand alone” units. The storage of the calculated prices can thus be on any of the computers involved.

When the time period for the contract expires, a check regarding the outcome of the contract, i.e. who owes whom money, can be made by either of the parties to the contract or by a third party, for example a so called Clearing House, said check being made by means of accessing the stored prices. Regardless of who carries out this check, it will usually be carried out by an automatic function used by the checking party, said function not being an integral part of the present invention. The check can also be carried out by this function in the case of certain other predefined significant events with an impact on the contract or the instruments underlying the contract. An example of such other significant events would be if, as mentioned initially, the contract is “triggered”, i.e. initiated, when an underlying instrument reaches a certain minimum or maximum level, so called “knock-in” or “knock-out”.

If the check is carried out by a Clearing House, the Clearing House will send an invoice to the paying party and transfer funds to the receiving party. The check might also be carried out by a so called Settlement Agent, i.e. a party whose specific function it is—in this context—to make such checks. The Settlement Agent does not transfer funds or send invoices, instead the agent sends notifications to the respective parties regarding who owes whom money, or sends invoices on behalf of the gaining party

The system of the invention also comprises another unit, said unit being a unit for price dissemination. This unit is preferably accesses by, or accesses, the unit for price calculation, and at certain points in time, for example at the expiry of a contract, spreads information regarding the contract to parties who have indicated an interest in such information, e.g. those involved on the contract and their brokers (of applicable). Other parties who might be interested could be news agencies and trading systems such as stock exchanges etc.

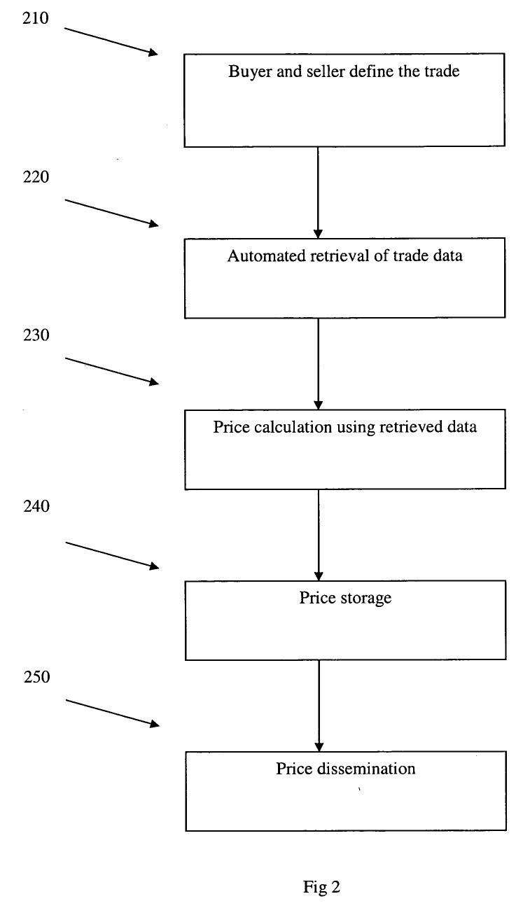

In conclusion and with reference to the flowchart in FIG. 2, the following major automated steps are comprised in a system which utilizes the units of the invention:

Two parties, an buyer and a seller agree on the contract, i.e. define it. (210)

Data regarding the contract is automatically retrieved at regular intervals from systems which hold said data, said systems being either internal or external with respect to the system on which the contract is agreed. (220)

Using the retrieved data, the value or price of the contract is calculated with an agreed upon frequency, usually corresponding to the retrieval frequency. (230)

The calculated prices are stored in a database from which they can later be retrieved. (240)

The price or value of the contract is disseminated to interested parties. (250).

In addition to being used by trading parties, Clearing Houses Settlement Agents etc, the present aspect of the invention can also be used by more or less any party wishing to retrieve and/or compile information regarding financial instruments. In such a case, it is envisioned that the present aspect of the invention would be executed on a computer belonging to a party selling the service to be described, said service being possible to subscribe to for a fee.

In this case, the invention could be said to comprise an automated system for retrieval and compilation of information regarding financial instruments.

Thus, the system would be more or less the same as that described hitherto, comprising an automated retrieval unit and an automated storage unit, which units would automatically retrieve and store the prices of a predefined number of financial instruments at predefined intervals in time. Suitably, the number and identity of the instruments which are to be stored would be defined by the operator of the system, and would ideally comprise all of the information in, for example, a stock exchange, which information would be retrieved and stored at intervals defined by the operator of the system.

Thus, a system according to the invention would also comprise an automated user interface, and a calculation unit. By means of the interface, a user will be able to, in interaction with the system, define a price to be calculated by the calculation means, the definition including the instrument for which the price is to be calculated and data to be given as output by the calculation. The output data could comprise at least one of the following group of parameters:
the maximum price between two user defined points in time;
the minimum price between said two user defined points in time;
the average price between said two user defined points in time.

Accordingly, the user can for example inform the system that he wishes to have the maximum and/or the minimum price of instrument A between date X and date Y. In addition, he can also request the average price of instrument Z between dates X′ and Y′.

As has been mentioned previously, the term average is ambiguous, since there are a number of principles by which an average can be calculated. It is envisioned that the interface means would give the user a number of choices between such predefined (by the operator of the system) principles, instead of defining the principle himself, although this would also be a possibility.

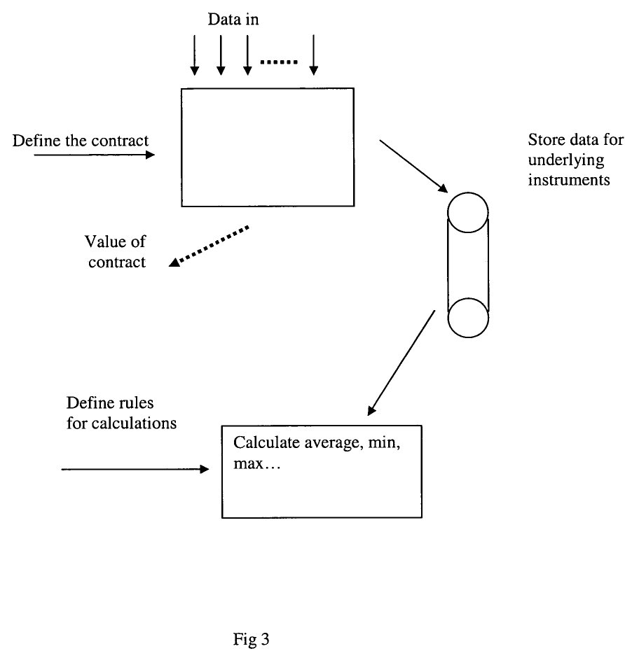

Another item which it would be possible to let the interface allow the user/subscriber to define would be at what points in time the data to be used for the calculation of the average price should come from, which would suitably be expressed as a number of predefined choices in the interface. Thus, for example, the subscriber could inform the system that he wants information on the average price of instrument A between dates X and Y, the average being calculated on the daily price of A at 11:30 AM. As mentioned initially, the present invention also comprises an aspect which deals with so called swaps. The aspects of the invention described in connection with FIGS. 1-3 are suitably combined with those aspects or embodiments which deal with swaps, but it should be pointed out that both aspects (complex prices/swaps) can also be used on their own, i.e. as “stand alone” functions.

In order to facilitate the reader's understanding of the aspect of the invention directed towards swaps, a brief description of a swap will now be given.

Swaps can be used for a large variety of different instruments and commodities, e.g. interests, pork bellies, oil prices etc, but the basic function of the swap is one and the same: to ensure that a person (legal or physical) will not be adversely affected by price fluctuations of a certain instrument or commodity over a defined period of time.

As an example, consider a person who will need a certain quantity of a certain commodity over a known period of time. A well known example is that of a baker who gets a contract to deliver a certain quantity of bread each week over a period of, for example, five years.

The price that the baker will be paid for each loaf of bread is specified in the contract, meaning that the baker will be extremely exposed to variations in the price of flour for the next five years. If the flour price decreases or stays the same, he won't have a problem. However, if the price of flour increases, this can seriously affect the baker's profit.

In conclusion, the baker needs to find a way of ensuring that the price of flour stays constant, or at least doesn't increase, over the next five years. This is the basic function of a swap, for which the baker turns to a party, for example a bank, which is willing to sell him the swap in question, for a certain price.

The basic conditions of the swap will be the following: Assume a price level Y for flour, usually the current price. During the period of the swap, in the example above five years, the price can either stay at Y, or vary to Y+ΔY. Thus, three cases can be discerned:
1. ΔY remains equal to zero.
2. ΔY differs from zero, and is positive, i.e. the price of flour increases.
3. ΔY differs from zero, and is negative, i.e. the price of flour decreases.

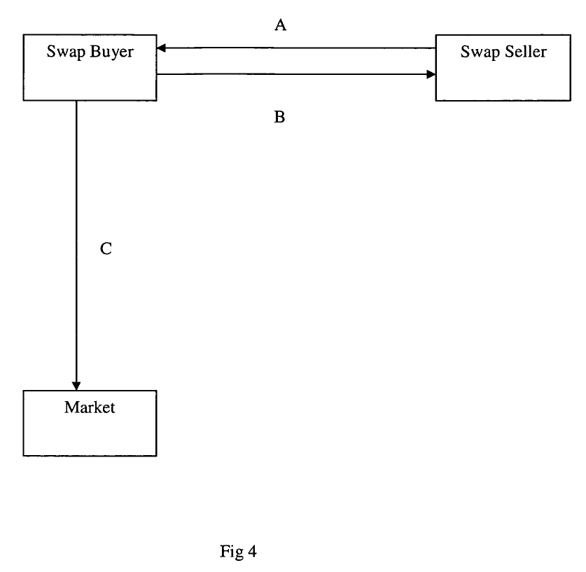

These three cases will be descried in the following, and are also schematically illustrated in the appended FIG. 4. In said drawing, the baker is more generally depicted as the “Swap buyer”, and the bank is referred to in a generic fashion as the “Swap seller”. The seller of flour is shown simply as the “Market”. As these generic names imply, the description, as well as the present aspect of the invention can be applied to a wide range of commodities as well as to, for example, interest rates. Possible directions of payments are shown in FIG. 1 with three arrows A, B, C. The swap will be based on a nominal price for the flour, the nominal price being referred to as Y.

Turning now to the three cases identified above, the following will happen in each of the cases:

Case 1: This is the case where the price Y of flour (“flour” here being used in a generic sense to refer to the commodity etc which the swap is based on) remains constant over the period of the swap. In this case, the only payment that will take place between the buyer and the seller of the swap is from the buyer to the seller, the payment being the price for the swap. Payment thus goes in the direction of arrow B. In addition, the buyer will keep on buying flour at the price Y from the market, i.e. there will be payment in the direction of arrow C.

Case 2: in this case, the price of flour increases, the increase being referred to as ΔY, with ΔY being a positive value. In this case, the baker will get the amount ΔY of the increase from the seller of the swap, while paying the price for the swap to the seller. Thus there will be payments both in the directions of arrows A and B. However, usually there will be a “netting” carried out, so that the baker only gets the difference between the price for the swap and ΔY from the seller of the swap, in order to minimize the number of transactions. Payment for the flour still goes from the buyer to the flour market, i.e. in the direction of arrow C.

Case 3: the price of flour decreases, the decrease also being referred to as ΔY, with ΔY in this case being negative. In this case, the buyer will buy flour at the lower price Y−ΔY from the market, while paying the difference, i.e. ΔY to the seller of the swap. Thus another important principle of a swap emerges: a buyer of a swap can't lose money if the price of the “flour”” increases, but neither can he profit from a decrease in the price of “flour”. Thus, the effect of the swap for the buyer of the swap is that the price will remain constant for the duration of the time period of the swap.

Another flow of events in the third case, with the same basic outcome as in that described above is the following: the buyer of the swap pays the seller of the swap the nominal price Y, and receives the price Y minus the decrease ΔY from the seller. Thus the net effect from buyer to seller will be Y to the buyer, and Y−ΔY from the buyer to the seller, i.e. Y−(Y−ΔY)=ΔY. The buyer of the swap will need to pay Y−ΔY for the flour as such, thus making his total payment ΔY+Y−ΔY=Y. In addition, the buyer of the swap will also still pay the seller of the swap the price of the swap as such, which is the same for all three of the cases identified above.

As mentioned initially, in contemporary systems agreements for swaps are made verbally, usually via telephone. One of the parties who have made the agreement then forwards the outline of the contract for approval to the other party, usually via telefax or regular mail. Once both parties have agreed on the outline of the contract, their respective “back office functions” will take over and finalize the details of the contract.

Due to the rather large number of people who will be involved in the work on the contract for a swap, there will be a substantial risk of delays and misunderstandings. The aspect of the invention which will now be described aims at eliminating or at least reducing these drawbacks to the present way of setting up swaps.

The present aspect of the invention comprises a number of sub-functions, one of them being a standardized user interface function. This is an automated function which can be executed in a number of configurations, for example either on both of the computers of the parties agreeing on a contract for a swap, or on one of their computers with the computer of the other party accessing the function. As an alternative, the function can be executed on the computer of a third party, i.e. a financial trading system, with both parties accessing the function via their respective computers.

The exact layout of the interface function can be designed in a number of ways, for which reason the interface will be described in writing below rather than by means of a figure or a drawing.

The following are the main parameters which can be filled in by the parties entering into the agreement, said parameters suitably being filled in while the parties are in verbal contact via telephone. Those parameters which have not yet been described will be described later in this text.

Parameters

The names of the parties.

The identity of the commodity on which the swap is based (“the flour”).

The notional value of the swap, i.e. the price level of the flour as stipulated in the swap.

The starting date of the swap.

The last day of the swap.

The price of the swap.

The so called “roll over period”, i.e. the frequency with which the price of “the flour” will be checked, and corresponding payments will be made. This period can be more or less arbitrary so long as there is agreement between buyer and seller, but the periods which are foreseen at present and which will be supported by the standardized interface are periods of one, three, six and twelve months.

The so called “rate set date”. The “roll over period” specifies how often the price of flour will be checked, but the “rate set date” specifies which price it is that will be checked. The rate set date can, for example, be the last day of the “roll over period”, or the date immediately preceding the last day of that period, or any other date which is agreed upon in the contract. In addition, a version which can be foreseen for future embodiments of the invention is aggregated periods of time, i.e. the average price of flour over a defined period of time.

In the function of the invention, both parties will fill in all of the parameters, as an alternative to which those parameters which are filled in by one party will be shown to the other party for approval. For those parameters which are filled in by both parties, the function will comprise a sub-function for checking that those parameters are filled in in the same way by both parties. If a parameter is filled in differently by the parties, the sub-function will generate an error message, and it will be impossible to finalize the contract before the parameter in question is agreed upon by the parties.

Yet a further alternative when it comes to filling in the parameters of the standardized interface is that one of the parties fills out all of the parameters comprised in the standardized interface function and submits it to the system, which then forwards it to the other party for approval.

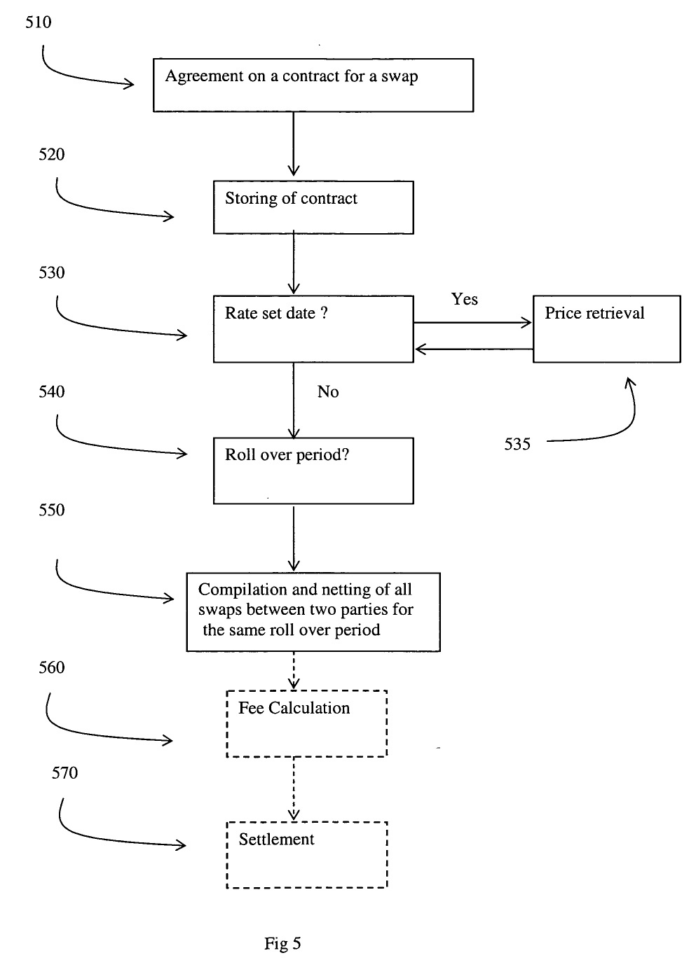

In FIG. 5, there is shown a rough flow chart of the some of the major steps of this aspect of the invention, said flow chart being commented on below.

Initially, two (ore more) parties agree on a swap, using the standardized interface described above, agreeing on all the parameters mentioned, block 510 of the flow chart.

As shown in block 520 of the flow chart, once the details of the contract are agreed upon, the finalized contract is stored in automatic means for this, also provided by the invention, and functioning together with the interface of the invention.

The function according to the invention also comprises a “watch dog function”, i.e. a function which, while the contract is stored watches for significant events which will affect the contract. Although this function is envisioned to be automated, the invention can also be used without this function, in which case the corresponding data would be given as manual input by an operator of the system. One event which would be watched for by this function, as shown in block 530 in FIG. 5, is if the Rate set date (explained above) occurs. On the Rate set date, the function will need to retrieve the relevant price (or prices) which have been agreed upon in the contract, i.e. the price of “flour” on the relevant day.

The retrieval of the relevant price—if the Rate set date occurs—is carried out by a special automated retrieval function, also comprised in this aspect of the invention, and indicated in block 535 of FIG. 5. The retrieval function suitably utilizes computerized means, which have an interface to a system, for example a stock exchange, where the relevant price can be found.

Another event which the “watch dog function” function (or a manual operator carrying out the same function) needs to check for is if the “roll over period” expires, block 540 of FIG. 5. When the roll over period expires or is about to expire, an automatic payment calculation function comprised in this aspect of the function carries out the following, block 550 of the flow chart in FIG. 5: using the data entered by the parties to the swap and stored by the storage function described above, block 510, the payments which should be made between the buyer and the seller of the swap, as shown in FIG. 4 with the arrows A and B, are calculated.

Another important feature of the automatic payment calculation function can now be discerned, said function being indicated in FIG. 5 by block 550: since the payment calculation function is automated, it can carry out a “netting” of the payments, i.e. see to it that payment only goes in one of the directions A or B in FIG. 4, which is done by calculating the total payment which should go between the parties of the swap. For example, if the buyer owes the seller 10 dollars, and the seller in turn owes the buyer 7 dollars, the automatic payment function will carry out a netting, and arrive at the result that the only payment which needs to be made is 3 dollars from buyer to seller.

In larger applications, the automatic price calculation function will compile and net all swap payments which are due on the same date, i.e. have roll over periods which have expiry dates that coincide with each other.

Thus, if for example two major banks have a multitude of swaps between them, the contracts having perhaps been entered into between a rather large number of regional offices, this would traditionally result in a large number of payments back and forth between the two banks. Using the swap aspect of the invention, all swaps between two parties which have roll over periods that expire on the same day, there will only be one payment in total between said two parties.

The payment calculation will thus compile and net all swaps between two parties for roll over periods which have the same expiry date.

Once the compilation is finished, but before the netting is commenced, the result of the compilation can, as an option, be displayed to the parties before the next step is taken. The purpose of displaying the result of the compilation and netting to the parties would be to give them a chance to correct the result. Such corrections would suitably be allowed by the price calculation function within a specified time window, following which corrections will not be allowed.

Two other sub-functions comprised in the “swap aspect” of the invention are also indicated in FIG. 5, using dotted lines since the functions are optional.

The first of the two optional sub-functions is fee calculation, as shown in block 560. If the parties involved in the swap (i.e. buyer and seller) utilize the services of a third party in order to access the swap aspect of the function, the third party will charge a fee for this.

The fee can be calculated in a number of ways, the main principle being that the way the fee is calculated is agreed upon when the parties in the swap contact the third party and agree to use the services of that party.

The second optional function is shown in block 570, and is referred to as “Settlement”. The purpose of this function is to carry out the actual monetary transaction calculated by the payment calculation function of block 550. This can be done if, for example, the swap function is executed by a third party, for example a major stock exchange, with which the parties of the swap have accounts. Thus, the amount calculated in block 550 would simply be transferred between the proper accounts. If the function indicated in block 570 is not comprised in the swap function, the function of block 550 could simply send invoices or payment messages to the parties involved in the swap.

1. An automated system for trading in one or several financial instruments, said system comprising a unit for calculating the price of an instrument which has been agreed upon between a first party, a seller, and a second party, a buyer, said unit comprising automated means for:
enabling the first and the second party to define, in interaction with the automated system, the instrument which is to be traded,
retrieving data regarding the instrument,
using said retrieved data to calculate a price for the instrument, and
storing said calculated prices.

2. The system of claim 1, in which the data retrieved is data regarding the components underlying the instrument of the trade.

3. The system of claim 1, additionally comprising automated means for dissemination of information, such as the price, regarding the trade in said instrument.

4. An automated system for retrieval and compilation of information regarding financial instruments, said system comprising an automated retrieval unit and an automated storage unit, said units automatically retrieving and storing, respectively, the prices of a predefined number of financial instruments at predefined intervals in time, the system in addition comprising automated interface means and calculation means for letting a user in interaction with the system define a price to be calculated by the calculation means, the definition including the instrument for which the price is to be calculated and data to be given by the calculation, said data comprising at least one of the following group of parameters:
the maximum price between two user defined points in time;
the minimum price between said two user defined points in time;
the average price between said two user defined points in time;

5. The system of claim 4, in which the user can, by means of the interface function, define how said average price is to be calculated, expressed as a choice between a number of predefined methods.

6. The system of claim 5, in which the user can also define, by means of the interface function, at what points in time the data to be used for the calculation of the average price should come from, expressed as a number of predefined choices.

7. A method for trading in one or several financial instruments in an automated system for financial trading, the method comprising automated calculation of the price of an instrument which has been agreed upon between a first party, a seller, and a second party, a buyer, the method additionally comprising using automated means for the steps of:
enabling the first and the second party to define the instrument which is to be traded,
retrieving data regarding the instrument,
using said retrieved data to calculate a price for the instrument, and
storing said calculated prices.

8. The method of claim 7, according to which the data retrieved is data regarding the components underlying the instrument of the trade.

9. The method of claim 7, additionally comprising the step of using automated means for dissemination of information, such as the price, regarding the trade in said instrument.

10. A method for the retrieval and compilation of information regarding financial instruments in an automated system for financial trading, said method comprising automated retrieval and automated storage, respectively, of the prices of a predefined number of financial instruments at predefined intervals in time, the method in addition comprising automated interaction with a user of said system, so that a user can define a price to be calculated by the system, the definition including the instrument for which the price is to be calculated and output data to be given by the calculation, said output data comprising at least one of the following group of parameters:
the maximum price between two user defined points in time;
the minimum price between said two user defined points in time;
the average price between said two user defined points in time;

11. The method of claim 10, including the step of letting the user, by means of said interaction, define how said average price is to be calculated, expressed as a choice between a number of predefined methods.

12. The method of claim 11, including the step of letting a user also define, by means of said interaction, the points in time from which the data to be used for the calculation of the average price should come from, expressed as a number of predefined choices.
